(19) United States
(12) Patent Application Publication
(10) Pub. No.: US 2022/0002844 A1
(43) Pub. Date: Jan. 6, 2022

(54) HIGH-STRENGTH ALUMINIUM ALLOYS FOR ADDITIVE MANUFACTURING OF THREE-DIMENSIONAL OBJECTS

(71) Applicant: AM Metals GmbH, Halsbrücke (DE)

(72) Inventor: Michael HÄRTEL, Freiberg (DE)

(21) Appl. No.: 17/309,155

(22) PCT Filed: Oct. 30, 2019
(86) PCT No.: PCT/EP2019/079677

§ 371 Date: Apr. 30, 2021

(30) Foreign Application Priority Data
Nov. 2, 2018 (DE) 10 2018 127 401.7

(51) Int. Cl. C22C 21/00; B33Y 10/00; B33Y 30/00; B33Y 70/00; B22F 10/28; B33Y 40/10; B22F 9/08; C22C 1/04; B23K 26/342

(52) U.S. Cl. CPC C22C 21/003; B33Y 10/00; B33Y 30/00; B33Y 70/00; B22F 2301/052; B33Y 40/10; B22F 9/082; C22C 1/0416; B23K 26/342; B22F 10/28

(57) ABSTRACT

The present invention relates to aluminium alloys in powder form having a content of at least two elements M from the group comprising Cr, Fe, Ni and Co and at least one element N from the group comprising Ti, Y and Ce, the alloy having a total amount of elements M in the range of 1 to 16 wt %, a total amount of elements N in the range of 0.5 to 5 wt % if the aluminium alloy contains Ti or Ce, and 1 to 10 wt %, if the aluminium alloy contains Y. Such aluminium alloys can be used in additive manufacturing processes, such as selective laser melting, to produce high-strength three-dimensional objects which can be used, for example, in engines for automobiles. The present invention further relates to processes and apparatuses for manufacturing three-dimensional objects from such aluminium alloys, processes for manufacturing such aluminium alloys in powder form, three-dimensional objects manufactured from such aluminium alloys in powder form, and specific aluminium alloys.

The invention relates to specific aluminium alloys in powder form having a content of two elements M from the group comprising Cr, Fe, Ni and Co and at least one element N from the group comprising Ti, Y, and Ce, the alloy having a total amount of elements M in the range of 1 to 16 wt %, a total amount of elements N in the range of 0.5 to 5 wt %, if the aluminium alloy contains Ti or Ce, and 1 to 10 wt %, if the aluminium alloy contains Y. The invention further relates to processes for the manufacture of such aluminium alloys, processes and apparatuses for additive manufacturing of three-dimensional objects, as well as three-dimensional objects produced according to these processes and specific aluminium alloys.

### STATE OF THE ART

Light metal components are the subject of intensive research in the manufacture of vehicles, especially automobiles, with the aim of continuously improving vehicle performance and fuel efficiency. Many light metal components for automotive applications today are made of aluminium and/or magnesium alloys. Such light metals can form load-bearing components that need to be strong and rigid and have good strength and ductility (e.g. elongation). High strength and ductility are particularly important for safety requirements and robustness in vehicles, such as motor vehicles. While conventional steel and titanium alloys provide high temperature resistance, these alloys are each either heavy or comparatively expensive.

A cost-effective alternative of light metal alloys for forming structural components in vehicles are alloys based on aluminium. These alloys can be conventionally processed into the desired components by bulk forming processes such as extrusion, rolling, forging, stamping, or casting techniques such as die casting, sand casting, investment casting (precision casting), chill casting and the like.

In addition to the use of light metal alloys for structural components, the use of the alloys for components in the engine compartment is of interest. However, the fact that high temperatures can prevail in the engine compartment causes difficulties here, so that components for use in this area must meet high requirements for strength and temperature resistance.

In recent years, “rapid prototyping” or “rapid tooling” has also gained importance in metal processing. These processes are also known as selective laser sintering and selective laser melting. In the process, a thin layer of a material in powder form is repeatedly applied and the material is selectively solidified in each layer in the areas where the later product is located by exposing it to a laser beam, by first melting the material at predetermined positions and then solidifying it. In this way, a complete three-dimensional body can be built up successively.

A process for the production of three-dimensional objects by selective laser sintering or selective laser melting as well as an apparatus for carrying out this process is disclosed, for example, in EP 1 762 122 A1.

Various aluminium alloys for selective laser melting are known from the prior art and are available on the market. These engineering materials are mainly AlSi materials such as AlSi10Mg, AlSi12, AlSi9Cu3, which, however, only have medium strengths and structural stabilities.

DE 10 2017 200 968 A1 describes aluminium alloys for the formation of high-temperature resistant alloys comprising aluminium, iron and silicon, which can be processed into three-dimensional objects by means of selective laser sintering or selective laser melting. The gist of DE 10 2017 200 968 A1 is that the molten precursor material is cooled at a rate of 1.0×10⁵K/second to a solid alloy component with a stable ternary cubic phase with high-temperature resistance and strength.

A high-strength alloy for additive manufacturing of the AlMgSc type is described in EP 3 181 711 A1. In these alloys, intermetallic Al—Sc phases have a strong strength-increasing effect, so that yield strengths of >400 MPa are achieved. However, the Sc required for these alloys, which is used in quantities in the range of 0.6 to 3 wt %, makes these alloys very cost-intensive and, moreover, the material is heavily dependent on the production of sufficient quantities of scandium. A further disadvantage is that the alloys described in EP 3 181 711 A1 are not suitable for application temperatures of >180° C., as the AlMg matrix tends to soften and creep.

Another approach for alloys for use in additive manufacturing are Al-MMC (MMC=Matrix Metal Composite) concepts, which have similar mechanical properties as AlMgSc alloys of EP 3 181 711 A1 at room temperature. However, the problem with these materials is that they show a significant drop in strength at temperatures above 200° C.

Another problem with the Al-MMC concepts is that the material consists of a powder mixture of three components, which makes transport, storage and reuse difficult, since a change in the mixing ratio cannot be ruled out due to the physical processes. Another disadvantage is the negative recycling behaviour of MMC metal-ceramic composite materials and the fact that the mechanical reworking of Al-MMC is more difficult and associated with higher costs.

Based on the prior art described above, there is a need for an aluminium alloy that is as cost-effective as possible, is thermally stable and has high-strength properties, and can be processed into three-dimensional objects with high strengths and stiffnesses and favourable corrosion properties by additive manufacturing techniques such as selective laser sintering and selective laser melting. Rare earth metals that are rare on the market, such as scandium, should be avoided as far as possible in order to ensure a high level of supply security. There is further a need for an additive processing process for the manufacture of three-dimensional objects and high-strength three-dimensional objects produced according to these processes.

This object is solved by an aluminium alloy in powder form as indicated by claim 1, by a process of manufacturing a three-dimensional object according to claim 10, by a process of manufacturing the powdered aluminium alloy according to claim 12, by a three-dimensional object produced using an aluminium alloy in powder form as indicated by claim 1 according to claim 13, by an apparatus for carrying out a process of manufacturing a three-dimensional object according to claim 14, and by an aluminium alloy as indicated by claim 15. Preferred embodiments of the invention are described in the dependent claims.

The aluminium alloy in powder form according to the invention is a powder for use in the manufacture of three-dimensional objects by means of additive manufacturing techniques. The aluminium alloy in powder form according to the invention contains at least two elements M from the group comprising Cr, Fe, Ni and Co and at least one element N from the group comprising Ti, Y and Ce, the alloy having a total amount of elements M in the range of 1 to 16 wt %, a total amount of elements N in the range of 0.5 to 5 wt %, if the aluminium alloy contains Ti or Ce, and 1 to 10 wt %, if the aluminium alloy contains Y.

Preferred aluminium alloys in powder form may be those which have a content of at least 0.5 and/or at most 8 wt % Fe, at least 0.5 and/or at most 4.0 wt % Cr and at least 0.5 and/or at most 4.0 wt % Ti and optionally up to 1.0 wt % Si and/or up to 1 wt % Zr and/or up to 1 wt % Ce. Further preferred are aluminium alloys in powder form comprising at least 0.5 and at most 8 wt % Fe, at least 0.5 and at most 4.0 wt % Cr and at least 0.5 and at most 4.0 wt % Ti, and optionally up to 1.0 wt % Si, up to 1 wt % Zr and up to 1 wt % Ce. In one embodiment, the aluminium alloy contains Si, Zr and Ce in an amount of at least 0.01 wt %.

According to the foregoing, the specified aluminium alloy in powder form expediently contains at least 0.5 wt %, preferably at least 3 wt % and further preferably at least 4 wt % of iron. The “specified aluminium alloy in powder form” means here and in the following the aforementioned aluminium alloy in powder form according to the general and the preferred embodiment. Alternatively, or in addition thereto, the specified aluminium alloy in powder form preferably contains at most 8 wt %, further preferably at most 7 wt %, and still further preferably at most 6 wt % iron (or at most 6 atomic % iron), wherein any of the specified upper limits may be combined with any of the specified lower limits or may define a range open in one direction. The specified aluminium alloy in powder form further suitably contains at least 0.5 wt %, preferably at least 2 wt %, and further preferably at least 3 wt % chromium. Alternatively, or in addition thereto, the specified aluminium alloy in powder form according to the general and the preferred embodiment preferably contains at most 4.5 wt %, and further preferably at most 3.8 wt %, of chromium, wherein each of the specified upper limits may be combined with each of the specified lower limits or may define a range open in one direction.

With respect to the total amount of iron, chromium and/or cobalt included in the aluminium alloy in powder form, contents of more than 1 wt % are considered preferred, of 1.5 wt % are considered more preferred and of 2 wt % are considered even more preferred.

In a particularly preferred embodiment of the invention, the aluminium alloy in powder form does not simultaneously contain relevant amounts of Fe and Co, i.e. if one of these elements is contained in the aluminium alloy according to the invention in a proportion of more than 0.5 wt % and in particular more than 1 wt %, the other element is contained in the aluminium alloy at most in a proportion of 0.1 wt % or less and preferably in a proportion of 0.05 wt % or less.

The specified aluminium alloy in powder form further suitably contains at least 0.5 wt %, preferably at least 1 wt %, and more preferably at least 1.5 wt % of titanium. Alternatively, or in addition thereto, the specified aluminium alloy in powder form preferably contains at most 4.5 wt %, and further preferably at most 3.5 wt %, of titanium, wherein each of the specified upper limits may be combined with each of the specified lower limits or may define a range open in one direction.

As the main constituent, the aluminium alloys in powder form contain aluminium, which preferably constitutes at least 90%, more preferably at least 95%, and still more preferably at least 98% of the portion missing to 100% of the aluminium alloy. Further non-aluminium constituents may be, for example, oxygen, which may be present as an oxide proportion on the surface of the powder particles. Other elements that may be present in the aluminium alloy in powder form are, for example, manganese or magnesium.

With respect to the total aluminium alloy in powder form, the aluminium proportion is preferably at least 80 wt %, and preferably at least 85 wt %. Alternatively, or in addition thereto, the specified aluminium alloy in powder form preferably contains at most 93 wt %, and more preferably at most 90.5 wt %, of aluminium, wherein any of the specified upper limits may be combined with any of the specified lower limits.

For silicon, a content of up to 3 wt % may be indicated as preferred, of up to 1.5 wt % as more preferred and of up to 0.5 wt % as still further preferred, wherein the indication “up to” may include or exclude a content of 0 wt % (or 0 atomic %, respectively). The same applies to the indication “up to 1 wt %” for the content of zirconium and cerium.

Further preferred aluminium alloys in powder form are those having a content of at least 3 and/or at most 7 wt %, preferably at least 4 and/or at most 6 wt % Fe, at least 2 and/or at most 4 wt %, preferably at least 3 and/or at most 3.8 wt % (or and/or 3.8 atom% Cr), at least 1 and/or at most 4 wt %, preferably at least 1.5 and/or at most 3.5 wt % Ti (or and/or 3.5 atom % Ti) and at least 80 and/or at most 93 wt %, preferably at least 85 and/or at most 90.5 wt % aluminium. Still further preferred aluminium alloys in powder form contain 3 to 7 wt %, preferably 4 to 6 wt % Fe, 2 to 4 wt %, preferably 3 to 3.8 wt % Cr (or 3 to 3.8 atom% Cr), 1 to 4 wt %, preferably 1.5 to 3.5 wt % Ti and 80 to 93 wt %, preferably 85 to 90.5 wt % aluminium.

Of the aforementioned elements, Ni, Y and Co, as well as the rare earth element Ce, act as glass formers in aluminium alloys and thus lead to the formation of larger amorphous regions in the alloy. This provides better corrosion properties to the alloy.

In addition, Ce, as well as Zr or Si, respectively, influence the phase formation of the alloy. In another preferred embodiment, the aluminium alloy according to the invention does not contain substantial amounts of Ce, i.e. less than 1 wt % Ce, preferably less than 0.5 wt %, further preferably less than 0.2 wt % Ce and still further preferably less than 0.05 wt % Ce.

The elements Ti, Fe and Cr have a significantly lower glass forming potential in aluminium alloys than Ni, Y and Co. However, it is possible to create a metastable superstructure with the desired properties through suitable process conditions such as setting as quickly as possible.

Alternative further preferred aluminium alloys in powder form are those having a content of at least 1 and/or at most 7.5 wt % Ni, at least 1 and/or at most 5.5 wt % Co and at least 2 and/or at most 10 wt % Y, as well as optionally up to 3.0 wt % Mn, and/or up to 1 wt % Zr. These aluminium alloys preferably have a content of 1 to 7.5 wt % Ni, 1 to 5.5 wt % Co and 2 to 10 wt % Y, as well as optionally up to 3.0 wt % Mn, and up to 1 wt % Zr. Particularly preferably, these aluminium alloys contain a minimum proportion of Mn and/or Zr of 0.01 wt %.

Further alternative preferred aluminium alloys in powder form are those having a content of at least 2 and/or at most 10 wt % Ni, at least 0.5 and/or at most 6 wt % Fe, and at least 0.5 and/or at most 5 wt % Ce as well as optionally up to 1 wt % Zr and/or up to 2.0 wt % for each of Gd, Nd or La. These aluminium alloys preferably have a content of 2 to 10 wt % Ni, 0.5 to 6 wt % Fe, and 0.5 to 5 wt % Ce as well as optionally up to 1 wt % Zr and/or up to 2.0 wt % for each of Gd, Nd or La. Particularly preferably, these aluminium alloys contain a minimum proportion of Zr and/or Gd and/or Nd and/or La of 0.01 wt %.

It is further preferred for the aluminium alloys in powder form according to the invention to contain up to 0.3 wt %, and preferably up to 0.25 wt %, of oxygen. It has been observed that a higher oxygen content in these ranges, e.g. of at least 0.05 wt %, in particular 0.1 to 0.3 wt % and preferably 0.15 to 0.25 wt %, imparts better flowability (determined by Hall Flow Test according to ISO 4490) to the powder particles.

The alloys described above were found to have a thermally stable, nanocrystalline structure reinforced by icosahedral phases and/or amorphous components. Conventionally, it has not been possible to produce complex components from such alloys, since these alloys are not castable, forgeable, (conventionally) sinterable or weldable. Against this background, it has surprisingly turned out that the alloys can be processed into complex components by means of laser melting processes and thus make components with highest strengths, stiffnesses or creep resistances at temperatures of up to 350° C. accessible. In addition, the products manufactured in this way can have improved wear resistance and/or corrosion properties.

With regard to the particle size, the aluminium alloys in powder form according to the invention are not subject to any significant limitations, wherein the particle size should be in a size range suitable for an additive process for the production of three-dimensional objects. A suitable particle size may be a mean particle size D50 in the range from 0.1 to 500 μm, preferably at least 1 and/or at most 200 μm, and particularly preferably at least 10 and/or at most 80 pm. Particularly preferred is a mean particle size d50 in the range of 10 to 80 μm.

Furthermore, it is preferred when at least 90 wt %, preferably at least 95 wt % and more preferably at least 98 wt % of the particles have a particle size in the range of 10 to 80 μm.

In the context of this invention, the particle sizes are to be determined in particular with the aid of laser diffraction processes (according to ISO 13320, with a HELOS device from Sympatec GmbH), wherein for the average particle size the specification D(numerical value), the numerical value stands for the proportion of particles (in percent) which are smaller than or equal to the specified particle size (i.e. with a D50 of 50 μm, 50% of the particles have a size of 50 μm). The diameter of a single particle may be optionally a respective maximum diameter (=supremum of all distances of each two points of the particle) or a sieve diameter or a volume-related equivalent sphere diameter.

For the aluminium alloy in powder form according to the invention, it is further preferred if the aluminium alloy underlying the powder has one or more of the following properties:
a strength, determined as yield strength, of >300 MPa and preferably >320 MPa, determined at 23° C.,
a hot yield strength of >200 MPa and preferably >250 MPa, determined at 250° C.,
a short time creep strength, determined as stress at a creep strain of 0.5% at 260° C. and a holding time of 6 min, of at least 200 MPa, preferably at least 220 MPa and even more preferably at least 240 MPa.

The “strength” describes the ability to withstand mechanical loads before failure occurs and is determined in the context of this invention according to the tensile test in accordance with DIN EN ISO 6892-1: 2017 A224. The “yield strength” describes the stress up to which a material exhibits no permanent plastic deformation under uniaxial and moment-free tensile load.

The hot yield strength refers to the yield strength at the specified temperature and is determined in the context of this invention in accordance with DIN EN ISO 6892-2:2011 A113.

The short time creep strength is determined in the context of this invention according to DIN EN ISO 6892-2:2011-05 A.

“Creep” designates the time- and temperature-dependent, plastic and load-induced deformation of a material. Creep strain refers to the plastic strain that occurs when a material creeps.

The aluminium alloys in powder form according to the invention can be produced by any process known to the skilled person for the production of alloys in powder form. A particularly useful process involves atomising the liquid aluminium alloy, whereby the aluminium alloy is heated to a suitable temperature and atomised. For atomisation, the aluminium alloy should have a temperature of >850° C., preferably of >950° C. and further preferably of >1050° C. Temperatures of more than 1200° C. are not necessary for atomisation and are less practical due to the higher energy requirement. Therefore, a range of >850 to 1200° C. and preferably >950 to 1150° C. can be specified as a particularly favourable temperature range for atomisation. It must be ensured by sufficient superheating of the melt or process control, respectively, that the above-mentioned temperatures prevail constantly at the nozzle in order to prevent undesired primary precipitation.

For the aluminium alloys in powder form mentioned above, it has been shown that, due to the composition in the starting material, high-melting particles of intermetallic phases (of Al—Ti compounds) of >20 pm can occur. Such particles can no longer be melted and dissolved with the surrounding material during subsequent processing as part of additive manufacturing of a three-dimensional object. In addition, it is possible that coarse high-melting intermetallic phases are also generated during melting in the course of alloying due to unfavourable process control, which can be detected on the section in the light microscope both in the powder particle and in the consolidated part. Since these particles can have a negative influence on the usage properties of three-dimensional objects produced from them, a post-processing can be appropriate, in which the aluminium alloy in powder form is melted under suitable melting conditions and atomised again.

Alternatively, the aluminium alloy in powder form according to the invention can also be produced by mechanical alloying. In this process, metal powders of the individual components of the subsequent alloy (or premixtures thereof) are intensively mechanically treated and homogenised down to the atomic level. For a modification of the particles, it is possible to post-process the obtained particles after mechanical alloying, for example to change the morphology, particle size or particle size distribution or to carry out a surface treatment. The post-processing may comprise one or more steps selected from chemical modification of the particles and/or the particle surface, sieving, crushing, grinding round, plasma spheroidising (i.e. processing into round particles) and additivation. In particular, modifications of the particle morphology or grain size distribution, respectively, are suitable, as mechanical alloying usually results in platelets or flakes. This form is generally problematic in a subsequent additive processing process.

According to the foregoing, the present invention accordingly relates to a process for the manufacture of an aluminium alloy in powder form, in particular an aluminium alloy in powder form for use in the processes described below, wherein a molten aluminium alloy having a composition as indicated above is atomised in a suitable apparatus, or an aluminium alloy in powder form having said composition is prepared by mechanical alloying and optionally post-processing.

For preferred embodiments of atomising, mechanical alloying and optional post-processing, reference is made to the foregoing.

Furthermore, the present invention relates to an aluminium alloy in powder form which is obtainable according to the described process by atomisation of the liquid alloy at a temperature of preferably >850° C. and further preferably >1050° C., or by mechanical alloying with optional post-processing, wherein reference is also made to the foregoing explanations for preferred embodiments of atomisation, mechanical alloying and optional post-processing.

Another aspect of the present invention relates to a process of manufacturing a three-dimensional object, wherein the object is manufactured by applying a build material layer upon layer and selectively solidifying the build material, in particular by supplying radiation energy, at locations in each layer associated with the cross-section of the object in that layer by scanning the locations with at least one area of action, in particular a radiant area of action of an energy radiation beam. In the context of the invention described herein, the build material comprises an aluminium alloy in powder form as specified in the foregoing. Preferably, the build material consists of this aluminium alloy in powder form.

The three-dimensional object may be an object made of one material (i.e. the aluminium alloy) or an object made of different materials. If the three-dimensional object is an object made of different materials, this object can be produced, for example, by applying the aluminium alloy according to the invention to a base body of the other material. The material different from the aluminium alloy according to the invention is expediently also an aluminium alloy, such as for example AlSi10Mg.

In the context of this process, it may be suitable if the aluminium alloy in powder form is preheated prior to selective solidification, wherein preheating to a temperature of at least 130° C. may be indicated as preferred, preheating to a temperature of at least 150° C. may be indicated as further preferred, and preheating to a temperature of at least 190° C. may be indicated as still further preferred. On the other hand, preheating to very high temperatures places considerable demands on the device for producing the three-dimensional objects, i.e. at least on the container in which the three-dimensional object is formed, so that as a reasonable maximum temperature for preheating a temperature of at most 400° C. can be indicated. Preferably, the maximum temperature for preheating is at most 350° C. and further preferably at most 300° C. The temperatures specified for preheating respectively denote the temperature to which the building platform, on which the aluminium alloy in powder form is applied, and the powder bed formed by the aluminium alloy in powder form are heated.

Another aspect of the present invention relates to a three-dimensional object made using an aluminium alloy in powder form, in particular made by the process described above, wherein the aluminium alloy in powder form is an aluminium alloy as described above and wherein the three-dimensional object comprises or consists of such an aluminium alloy. By using the alloys specified above for the production of such objects, very good “as built” surfaces are obtainable, so that subsequent post-treatments of the surface can be minimised.

Another aspect of the present invention relates to a manufacturing apparatus for carrying out a process for manufacturing a three-dimensional object as indicated above, wherein the apparatus comprises a laser sintering or laser melting device, a process chamber configured as an open container having a container wall, a carrier located in the process chamber, wherein the process chamber and the carrier are movable relative to each other in the vertical direction, a storage container and a coater movable in the horizontal direction, and wherein the storage container is at least partially filled with an aluminium alloy in powder form as indicated above.

Additive manufacturing devices for the production of three-dimensional objects and associated processes are generally characterised in that objects are produced in them by solidifying a shapeless build material layer by layer. The solidification can be brought about, for example, by supplying thermal energy to the build material, by irradiating it with electromagnetic radiation or particle radiation, for example in laser sintering (“SLS” or “DMLS”) or laser melting or electron beam melting.

For example, in laser sintering or laser melting, the exposure area of a laser beam (“laser spot”) on a layer of the build material is moved over those areas of the layer that correspond to the object cross-section of the object to be produced in this layer. Instead of applying energy, the selective solidification of the applied build material can also be performed by 3D printing, for example by applying an adhesive or binder. In general, the invention relates to the manufacture of an object by means of application in layers and selective solidification of a build material, irrespective of the manner in which the build material is solidified.

In the context of the invention described here, it is preferred that individual particles of a build material are bonded together without the use of an adhesive or binder, but solely by the supply of radiation energy. In this case, the mechanical properties of the aluminium alloy can be adjusted within certain limits by selecting suitable parameters. Thus, it may be preferred to operate the laser within the scope of the specified manufacturing device with a power of about 310 W in order to produce, for example, a hardness of the aluminium alloy according to the invention in the range of 140-155 HBW 2.5/62.5, measured according to Brinell—DIN EN ISO 6506-1:2015. Alternatively, it may be preferred to operate the laser in the context of the specified manufacturing device at a power of about 220 W to produce, for example, a hardness of the aluminium alloy according to the invention in the range of 145-170 HBW 2.5/62.5, measured according to Brinell—DIN EN ISO 6506-1:2015.

Various types of build materials can be used, in particular powders such as metal powders, plastic powders, ceramic powders, sand, filled or mixed powders. In the context of the present invention, the aluminium alloy in powder form according to the invention is used at least proportionally as a build material.

Other features and embodiments of the invention can be found in the description of an exemplary embodiment with the aid of the accompanying drawings.

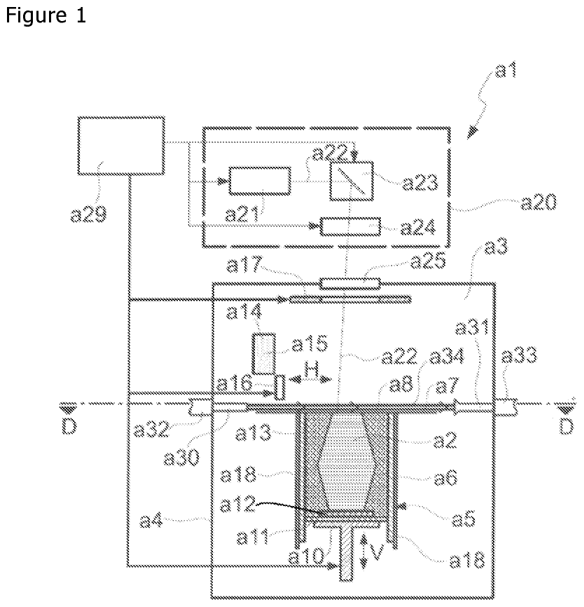

FIG. 1 shows a schematic illustration, partially reproduced as a cross-section, of an apparatus for the layer-by-layer construction of a three-dimensional object according to an embodiment of the present invention.

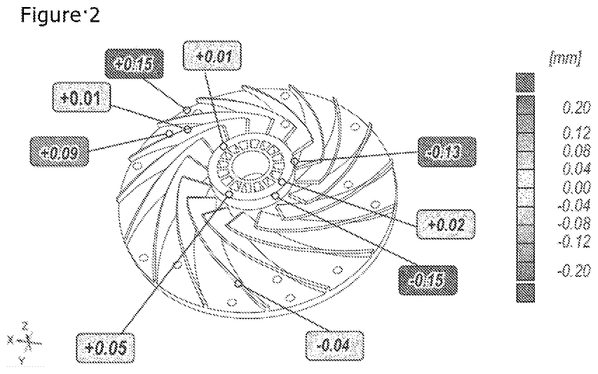

FIG. 2 shows a surface comparison of an impeller prepared by selective laser melting from an aluminium alloy in powder form according to the invention.

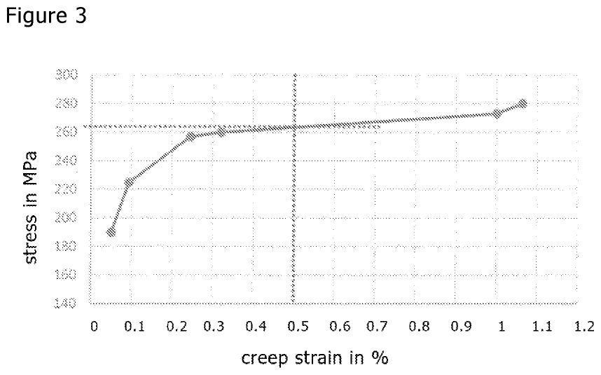

FIG. 3 shows the determination of the short time creep strength of a test body made of an aluminium alloy in powder form according to the invention.

The apparatus shown in FIG. 1 is a laser sintering or laser melting apparatus a1 known per se. For the construction of an object a2 it contains a process chamber a3 with a chamber wall a4. In the process chamber a3, an upwardly open construction container a5 with a wall a6 is arranged. A working plane a7 is defined by the upper opening of the construction container a5, wherein the area of the working plane a7 lying within the opening, which can be used to build the object a2, is referred to as the construction site a8. A carrier a10, which is movable in a vertical direction V, is arranged in the container a5, to which a base plate all is attached, which terminates the construction container a5 at the bottom and thus forms its base. The base plate all may be a plate formed separately from the carrier a10, that is attached to the carrier a10, or it may be formed integrally with the carrier a10. Depending on the powder and process used, the base plate all may also have a build platform a12 on which the object a2 is built. However, the object a2 can also be built on the base plate all itself, which then serves as the building platform. In FIG. 1, the object a2 to be formed in the building container a5 on the building platform a12 is shown below the working plane a7 in an intermediate state with several solidified layers surrounded by building material a13 that has remained unsolidified. The laser sintering device al further comprises a storage container a14 for a powdery build material a15 which can be solidified by electromagnetic radiation and a coater a16 movable in a horizontal direction H for applying the build material a15 to the construction site a8. The laser sintering device al further comprises an exposure device a20 with a laser a21 which generates a laser beam a22 as an energy radiation beam which is deflected via a deflection device a23 and focused onto the working plane a7 by a focusing device a24 via a coupling window a25 which is provided on the upper side of the process chamber a3 in its wall a4.

Further, the laser sintering apparatus al includes a control unit a29 through which the individual components of the apparatus al are controlled in a coordinated manner to perform the building process. The control unit a29 may include a CPU whose operation is controlled by a computer program (software). The computer program may be stored separately from the apparatus on a storage medium from which it can be loaded into the device, in particular into the control unit. In operation, to apply a powder layer, the carrier a10 is first lowered by a height corresponding to the desired layer thickness. By moving the coater a16 over the working plane a7, a layer of the powdered build material a15 is then applied. For safety, the coater a16 pushes a slightly larger amount of build material a15 in front of it than is required to build up the layer. The coater a16 pushes the systematic excess of build material a15 into an overflow container a18. An overflow container a18 is arranged on both sides of the construction container a5. The build material in powder form a15 is applied at least over the entire cross-section of the object a2 to be produced, preferably over the entire construction site a8, i.e. the area of the working plane a7, which can be lowered by a vertical movement of the carrier a10. Subsequently, the cross-section of the object a2 to be produced is scanned by the laser beam a22 with a radiation exposure area (not shown), which schematically represents an intersection of the energy radiation beam with the working plane a7. As a result, the build material in powder form a15 is solidified at locations corresponding to the cross-section of the object a2 to be produced. These steps are repeated until the object a2 is completed and can be removed from the construction container a5. For generating a preferably laminar process gas stream a34 in the process chamber a3, the laser sintering device al further comprises a gas supply channel a32, a gas inlet nozzle a30, a gas outlet opening a31 and a gas discharge channel a33. The process gas stream a34 moves horizontally across the construction site a8. The gas supply and discharge may also be controlled by the control unit a29 (not shown). The gas extracted from the process chamber a3 may be fed to a filter device (not shown), and the filtered gas may be fed back to the process chamber a3 via the gas feed duct a32, forming a recirculation system with a closed gas loop. Instead of only one gas inlet nozzle a30 and one gas outlet opening a31, several nozzles or openings can be provided in each case.

In the apparatus according to the invention, the storage container a14 is at least partially filled with an aluminium alloy in powder form a15 as indicated above.

Finally, another aspect of the present invention relates to an aluminium alloy having a content of 2 to 8 wt % Fe, 0.5 to 4.0 wt % Cr and 0.5 to 4.0 wt % Ti, and optionally up to 3.0 wt % Si and/or up to 1 wt % Zr and/or up to 1 wt % Ce, wherein the total amount of Fe, Cr and Ti in the alloy is at least 10 and/or at most 16 and preferably at least 11 and/or at most 13 wt %. A particularly preferred aluminium alloy contains 5.1±1 wt % Fe, 3.5±1 wt % Cr and 2.5±1 wt % Ti, and a total amount of Si, Mn, Mg and 0 of 0.05 to 1 wt % and in particular 0.1 to 0.6 wt % can be stated as further preferred.

The present invention is further illustrated by a number of examples which, however, should not be construed as in any way determining the scope of protection of this application.

The aluminium alloys and three-dimensional objects below were characterised using the methods described below:

The mean particle size D50 was determined according to ISO 13320 using a HELOS device from Symphatex GmbH.

The bulk density was determined according to ISO 3923/1 with a Hall flowmeter.

The flowability was determined according to ISO 4490 with a Hall flowmeter, 2.5 mm.

Densities are determined using the Archimedes principle according to ISO 3369: “Undurchlassige Sintermetallwerkstoffe and Hartmetalle-Bestimmung der Dichte” for three-dimensional objects produced as density cubes by selective laser sintering or selective laser melting. In this density measurement method, the mass of a sample is measured in both air and water and the measured mass difference between the two measurements is then used to estimate the sample volume based on the known density of water. The measured weight and volume of the sample can then be used to calculate its density. For the tests, all sides of the density cube samples are manually sanded with Struers SiC#320 sandpaper using a Struers Labo-Pol-5 sample preparation system to reduce surface roughness and thus the possibility of falsifying the test result due to trapped air bubbles on the sample surfaces. Ion-exchanged water is used for weighing when immersed in water, and a small amount of dishwashing liquid is added to the water to reduce its surface tension.

The procedure is carried out with a laboratory scale (Kern PLT 650-3M) using a built-in density calculation programme. For the automatic calculation, the water temperature is measured before the tests. The measurements are repeated five times for each sample, switching the sample between each measurement, and the samples are thoroughly dried before each new measurement. The results shown below are the averaged values of the five repetitions.

The determination of tensile strength, yield strength, elongation at break and E-modulus was carried out according to the tensile test in accordance with the standard DIN EN ISO 6892-1: 2016 “Metallische Werkstoffe-Zugversuch-Teil 1: Prüfverfahren bei Raumtemperatur”. Three-dimensional objects produced by selective laser sintering or selective laser melting as tensile test pieces (specimens) are used for tensile tests. The cross-sectional diameter of each specimen is reduced with a lathe so that it reaches its smallest value, about 5.0 mm, in the middle of the specimens. This diameter is checked with a micrometer.

The ends of the specimens are threaded for attachment. The test is carried out e.g. with the universal testing machine inspekt table 50 kn (Hegewald & Peschke Mess-und Prüftechnik GmbH). The tensile force is increased by 10 MPa/s during the elastic phase of the material behaviour and reduced to 0.375 MPa/s at the start of the plastic deformation phase.

During the tests, the maximum load, the yield strength (Rp0.2 limit), the tensile strength, the E-modulus and the elongation at break of the specimens are recorded and then the reduction in cross-sectional area at the point of break is measured with a caliper.

The properties of hot tensile strength, E-modulus, hot yield strength and elongation at break at 250° C. were determined according to DIN EN ISO 6892-2:2011 A113.

The hardness testing of the three-dimensional objects produced as samples by selective laser sintering or selective laser melting is performed using the Brinell method according to the standard DIN EN ISO 6506-1: 2015 “Metallische Werkstoffe-Härteprüfung nach Brinell-Teil 1: Prüfverfahren”. Samples of density cubes are used for testing.

The tests are performed three times for each sample and the measured values are given with an accuracy of 1 HBW. The numerical data given below indicate the sphere diameter of the test sphere used in the determination (e.g. 2.5 mm) and the test load (e.g. 62.5 kp).

The thermal conductivity was determined according to the formula λ=a·cp·ρ from the measured thermal diffusivity a LFA (Laser Flash method measuring device 427/company Netzsch Ar atmosphere 100 ml/min, two built samples each: discs with a diameter of 12.6 mm and a thickness of 3 to 3.5 mm, plane parallel faces, temperature range 21 to 250° C.), the specific heat capacity cp and the temperature-dependent density ρ, taking into account the measured thermal expansion αtechn. The Laser Flash measuring method is a measuring method for the direct determination of the thermal diffusivity. Here, a sample is heated for a short moment by means of a laser. To be able to carry out a measurement, the sample is first placed in a sample holder and covered with a graphite layer that absorbs thermal radiation. Then the sample holder together with the sample is placed in the system, where it is brought to the desired measuring temperature by an oven. Once the temperature is reached, a defined amount of heat is introduced into the sample with an excitation pulse. A detection laser is then used to determine the heat reflection of the sample on the other side of the sample holder. This usually shows an increase in the sample temperature after the heat input and then a slow drop, which can be steeper or flatter depending on the thermal diffusivity of the sample. From this data, the thermal conductivity is calculated directly by means of a mathematical model.

The specific heat capacity cp was determined using a Setaram high temperature calorimeter, at a measurement interval of 80 to 250° C., 5 K/min heating rate, He atmosphere, continuous comparison method, two built samples each: cylinders with 4.9 mm diameter and 16 mm length, plane parallel faces.

The thermal expansion αtechn was determined using a DIL 402 C dilatometer, measuring range 20 to 250° C., 5 K/min heating rate in He atmosphere, specimens: two built specimens each: cylinder with 4 mm diameter and 25 mm length, plane parallel faces.

The values given for the specific heat capacity and thermal expansion are mean values of the measured samples.

### EXAMPLE 1

Various aluminium alloys in powder form were produced with the compositions and properties given in Table 1 below:

TABLE 1

| alloy number | 1 | 2 | 3 |
|---|---|---|---|
| Fe in wt % | 5.8 | 5.6 | 4.5 |
| Cr in wt % | 3.5 | 3.5 | 3.5 |
| Ti in wt % | 3.2 | 3.1 | 3 |
| O in wt % | 0.09 | 0.23 | 0.16 |
| Si in wt % | | 0.17 | 0.16 |
| Mn in wt % | | 0.06 | 0.04 |
| Mg in wt % | | 0.03 | 0.02 |
| Al in wt % | balance to | balance to | balance to |
| | 100% | 100% | 100% |
| Properties | | | |
| Mean particle | 35.8 | 31.9 | 36.5 |
| size D50 in μm | | | |
| Flowability (FG | 67 | 27.5 | 61 |
| Hall) in s | | | |
| bulk density in | 1.45 | 1.60 | 1.51 |
| g/cm³ | | | |

The smaller particle size of aluminium alloy 2 provided improved surface quality and reduced crack sensitivity in the manufacture of three-dimensional objects compared to aluminium alloy 1. Aluminium alloy 2 has a higher bulk density and also showed better flowability, which is probably due to the higher oxygen content leading to a reduction of the forces between the particles. Alloy 3 combines the advantageous properties of alloys 1 and 2.

The powders consisted of coarse and mainly spherical particles. While aluminium alloy 1 contained few particles with a size of less than 10 μm, aluminium alloy 2 contained a substantial amount of fine particles in the powder. Powder 3 was characterised by a smaller amount of fines compared to powder 2. With these powders, layer thicknesses of 20 to 60 μm could be reliably produced.

### EXAMPLE 2

Three-dimensional test objects were produced with an EOS M290 (EOSPrint version 2.x, laser power 270 W, line speed 850 mm/s, hatch distance 0.1 mm, layer thickness 0.05 mm), using the aluminium alloy 3.

For this purpose, a preheating temperature of 195° C. was set in the sample chamber. With the aluminium alloys, densities of >99% for the manufactured objects could be achieved. The objects made of aluminium alloy 1 showed a slightly higher sensitivity to brittle cracks.

Complex test objects could be produced with the aluminium alloys. A manufactured impeller with the dimensions showed maximum deviations from the specification of ±0.15 mm (see FIG. 2).

The following properties were determined for samples made of aluminium alloy 3 with a density of 2.9 g/cm³:

TABLE 2

| | tensile test at | | | |
|---|---|---|---|---|
| | room | | test cube | test cube |
| | temperature | at 250° C. | at 20° C. | at 250° C. |
| treatment | as prepared | as prepared | stabilised* | stabilised* |
| tensile strength | 450 | 310 | | |
| in MPa - vertical | | | | |
| building direction | | | | |
| tensile strength | 450 | 310 | | |
| in MPa - | | | | |
| horizontal | | | | |
| building direction | | | | |
| yield strength in | 340 | 270 | | |
| MPa - vertical | | | | |
| building direction | | | | |
| yield strength in | 360 | 290 | | |
| MPa - horizontal | | | | |
| building direction | | | | |
| elongation at | 4 | 6 | | |
| break in % | | | | |
| E-modulus in GPa | 85 | 75 | | |
| hardness in HBW | 154 | | | |
| 2.5/62.5 | | | | |
| thermal | | | 61-70 | 77-81 |
| conductivity in | | | | |
| W/(m · K) | | | | |
| heat capacity in | | | 0.844 | 0.928 |
| kJ/(kg · K) | | | | |
| thermal | | | 19.7 | 21.1 |
| expansion in 10⁻⁶ | | | | |
| K⁻¹ | | | | |

=tempering at 350° C. for 10 h

In addition, galvanic corrosion studies were carried out, wherein the samples made of aluminium alloy 1 were compared with corresponding samples made of Al 99.5. A saturated calomel electrode was used as the reference electrode. The measurements were carried out in 0.01 M NaCl solution at 25° C. with a platinum sheet as counter electrode. This showed a significantly lower negative potential for the aluminium alloy according to the invention compared to the sample made of Al 99.5.

### EXAMPLE 3

### Determination of the Short Time Creep Strength of Aluminium Alloy 1

The short time creep strength of aluminium alloy 1 was determined according to DIN EN ISO 6892-2:2011-05 A. For this purpose, samples were brought to different stress levels at 260° C. and then kept under constant stress. The permanent elongation resulting after 6 min is recorded as a measured value. The stress at which 0.5% elongation results is used as the reference value for the comparison.

The results of these tests are shown in FIG. 3. For the aluminium alloy 1, a short time creep strength, determined as stress at a creep strain of 0.5% at 260° C. and a holding time of 6 min, of about 260 MPa could be determined, which is significantly higher than the short time creep strength described for other aluminium alloys (in the range of 9 to 170 MPa). For additively manufactured Al-MMC, a short time creep strength of 170 MPa was determined (not shown).

1. An aluminium alloy in powder form having a content of at least two elements M from the group comprising Cr, Fe, Ni and Co and at least one element N from the group comprising Ti, Y and Ce,
wherein the alloy has a total amount of elements M in the range of 1 to 16 wt %, a total amount of elements N in the range of 0.5 to 5 wt %, if the aluminium alloy contains Ti or Ce, and 1 to 10 wt %, if the aluminium alloy contains Y.

2. The aluminium alloy in powder form according to claim 1, wherein the aluminum alloy contains at least 0.05 wt % oxygen.

3. The aluminium alloy in powder form according to claim 1 having a content of at least 0.5 or at most 8 wt % Fe, at least 0.5 or at most 4.0 wt % Cr and at least 0.5 or at most 4.0 wt % Ti.

4. The aluminium alloy in powder form according to claim 3 having a content of at least 3 or at most 7 wt %, Fe, at least 2 or at most 4 wt % Cr, at least 1 or at most 4 wt %Ti and at least 80 or at most 93 wt % aluminium.

5. The aluminium alloy in powder form according to claim 1 having a content of at least 1 or at most 7.5 wt % Ni, at least 1 or at most 5.5 wt % Co and at least 2 or at most 10 wt % Y.

6. The aluminium alloy in powder form according to claim 1 having a content of at least 2 or at most 10 wt % Ni, at least 0.5 or at most 6 wt % Fe, and at least 0.5 or at most 5 wt % Ce.

7. The aluminium alloy in powder form according to claim 1, wherein the aluminum alloy has a mean particle size D50 in the range from 0.1 to 500 μm.

8. The aluminium alloy in powder form according to claim 1, wherein the aluminium alloy on which the powder is based has a strength, determined as yield strength, of >300 MPa determined at 23° C., or a hot yield strength of >200 MPa determined at 250° C., or
a short time creep strength, determined as stress at a creep strain of 0.5% at 260° C. and a holding time of 6 min, of at least 200 MPa.

9. The aluminium alloy in powder form according to claim 1, obtainable by atomisation of a liquid alloy at a temperature of >850° C., or by mechanical alloying.

10. A process of manufacturing a three-dimensional object, wherein the object is produced by applying a build material layer upon layer and selectively solidifying the build material, by supplying radiation energy, at locations in each layer which are associated with the cross-section of the object in that layer, by scanning the locations with at least one radiation exposure area of an energy radiation beam, wherein the build material comprises an aluminium alloy in powder form according to claim 1.

11. The process according to claim 10, wherein the aluminium alloy in powder form is preheated, preferably to a temperature of at least 130° C.

12. A process of manufacturing an aluminium alloy in powder form wherein a molten aluminium alloy having a composition as specified in claim 1 is atomised in a suitable apparatus, or an aluminium alloy having said composition is produced by mechanical alloying.

13. A three-dimensional object, produced using an aluminium alloy in powder form wherein the aluminium alloy in powder form is an aluminium alloy as specified in claim 1, and wherein the three-dimensional object comprises of such an aluminium alloy.

14. A manufacturing apparatus for carrying out a process, wherein the apparatus comprises a laser sintering or laser melting device, a process chamber including an open container with a container wall, a carrier located in the process chamber, wherein the process chamber and the carrier are movable relative to each other in the vertical direction, a storage container and a coater movable in the horizontal direction, and wherein the storage container is at least partially filled with an aluminium alloy in powder form according to claim 1.

15. An aluminium alloy having a content of 2 to 8 wt % Fe, 0.5 to 4.0 wt % Cr and 0.5 to 4.0 wt % Ti and up to 3.0 wt % Si or up to 1 wt % Zr or up to 1 wt % Ce, characterised in that wherein the total amount of Fe, Cr and Ti in the alloy is at least 10 or at most 16.
